(19) United States
(12) Patent Application Publication
(10) Pub. No.: US 2026/0235833 A1
(43) Pub. Date: Aug. 13, 2026

(54) OPTICAL WAVEGUIDE SUBSTRATE HAVING OPTICAL WAVEGUIDE STRUCTURE, OPTICAL MODULE, AND INFORMATION PROCESSING APPARATUS

(71) Applicant: Fujitsu Limited, Kawasaki-shi (JP)

(72) Inventors: Nami YASUOKA, Kamakura (JP); Kouichi SUZUKI, Kawasaki (JP)

(73) Assignee: Fujitsu Limited, Kawasaki-shi (JP)

(21) Appl. No.: 19/463,624

(22) Filed: Jan. 29, 2026

(30) Foreign Application Priority Data
Feb. 10, 2025 (JP) 2025-019980

(51) Int. Cl. G02B 6/43; G02B 6/125

(52) U.S. Cl. CPC G02B 6/43; G02B 6/125

(57) ABSTRACT

An optical waveguide substrate includes a support layer, and an optical waveguide forming layer including a core portion forming layer. The optical waveguide forming layer includes a first optical waveguide and a second optical waveguide. Each of the first and the second optical waveguides includes a core portion including a first core portion and a second core portion and extending along a light transmission direction in the core portion forming layer, and a side cladding portion. The second core portion is disposed along both side surfaces of the first core portion. The side cladding portion is disposed on a side surface of the second core portion. A refractive index of the second core portion is smaller than that of the first core portion, and a refractive index of the side cladding portion is smaller than that of the second core portion.

### CROSS-REFERENCE TO RELATED APPLICATION

This application is based upon and claims the benefit of priority of Japanese Patent Application No. 2025-019980 filed on Feb. 10, 2025, the entire contents of which are incorporated herein by reference.

### FIELD

A certain aspect of the present embodiments relates to an optical waveguide substrate having an optical waveguide structure, an optical module, and an information processing apparatus.

### BACKGROUND

As a structure of a conventional cross waveguide, a structure in which a core layer is embedded in a substrate is known (for example, see Non-Patent Document 1: Kai Wang et.al.; “Photolithographically Manufactured Acrylate Polymer Multimode Optical Waveguide Loss Design Rules”; 2008 2nd Electronics System-Integration Technology Conference). In recent years, artificial intelligence (AI) technology has been remarkably advanced, and electronic devices applicable to AI learning devices have been actively developed. Optical waveguides are suitable for applications in which a large amount of information is processed at high speed. For example, OE (Optical-Electrical) chips are disposed at ends of the optical waveguide formed on a substrate. Depending on the arrangement of the OE chips connected by the optical waveguides on the substrate, the optical waveguides may intersect each other on the substrate. In the structure disclosed in Non-Patent Document 1, it is confirmed that a loss occurs at the intersection of the optical waveguides. A structure for reducing the loss at the intersection of the optical waveguides has also been proposed (for example, see Patent Document 1: Japanese Patent Application Publication No. 2013-174840). Patent Document 1 discloses a configuration in which optical waveguides intersect with each other for the purpose of reducing the loss and the interference at an intersection portion. Specifically, Patent Document 1 discloses an aspect in which a low refractive index layer having a refractive index lower than refractive indexes of a first core portion and the intersection portion is provided between the first core portion and the intersection portion. In addition, Patent Document 1 also discloses an aspect in which a low refractive index layer having a refractive index lower than refractive indexes of a second core portion and the intersection portion is provided between the second core portion and the intersection portion.

### SUMMARY

According to an aspect of the present disclosure, there is provided an optical waveguide substrate having an optical waveguide structure including: a support layer; and an optical waveguide forming layer including a lower cladding layer provided on the support layer, a core portion forming layer provided on the lower cladding layer, and an upper cladding layer provided on the core portion forming layer; wherein the optical waveguide forming layer includes a first optical waveguide and a second optical waveguide intersecting the first optical waveguide, each of the first optical waveguide and the second optical waveguide includes a core portion extending along a light transmission direction in the core portion forming layer, and a side cladding portion, the core portion includes a first core portion and a second core portion, the second core portion is disposed along both side surfaces of the first core portion in a cross section along a thickness direction of the optical waveguide forming layer, the side cladding portion is disposed on a side surface of the second core portion opposite to a side on which the first core portion is located in the cross section along the thickness direction of the optical waveguide forming layer, a refractive index of the second core portion is smaller than a refractive index of the first core portion, and a refractive index of the side cladding portion is smaller than the refractive index of the second core portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a plan view schematically illustrating an example of an optical module in which an optical waveguide substrate of a first embodiment is used.

FIG. 1B is a front view of the optical module illustrated in FIG. 1A.

FIG. 1C is an enlarged view of a first information processing unit and its surroundings illustrated in FIG. 1A.

FIG. 2A is an enlarged view of optical waveguides formed in the optical waveguide substrate illustrated in FIG. 1A.

FIG. 2B is a diagram illustrating a curved waveguide of a curved portion of the optical waveguide.

FIG. 3 is a cross-sectional view taken along a line A1-A1 in FIG. 1C.

FIG. 4A is a cross-sectional view of an optical waveguide-forming layer taken along a line A2-A2 in the enlarged view of FIG. 2A.

FIG. 4B is a diagram schematically illustrating a state in which light travels in the optical waveguide formed in the optical waveguide substrate of the first embodiment.

FIG. 5A is a cross-sectional view schematically illustrating a conventional optical waveguide.

FIG. 5B is a diagram schematically illustrating a state in which light travels in the conventional optical waveguide.

FIG. 6 is a diagram illustrating an example of an information processing apparatus on which the optical module using the optical waveguide substrate of the first embodiment is mounted.

FIGS. 7A to 7I are diagrams illustrating a manufacturing process of the optical waveguide substrate of the first embodiment.

FIG. 8 is a cross-sectional view schematically illustrating an optical waveguide according to a second embodiment.

FIGS. 9A to 9G are diagrams illustrating a manufacturing process of an optical waveguide substrate of the second embodiment.

FIG. 10 is a diagram schematically illustrating an optical waveguide of a modified structure example.

FIG. 11A is a diagram illustrating an example of a package substrate in which an optical module is mounted on a printed substrate.

FIG. 11B is a front view of the package substrate illustrated in FIG. 11A.

FIG. 11C is an explanatory view of a mounting portion of the optical connector.

FIG. 12A is a diagram illustrating a result of an FDTD simulation performed using the structure of an example.

FIG. 12B is a diagram illustrating a result of an FDTD simulation performed using the structure of the conventional example.

FIG. 13A is a plan view illustrating an optical waveguide substrate of the example.

FIG. 13B is a plan view illustrating an optical waveguide substrate of a conventional example.

FIG. 14 is a graph illustrating the dependence of the transmission efficiency on the width of the second core portion and the propagation efficiency of the structure of the conventional example, based on the results of the FDTD simulation of light in the optical waveguide substrate of the example.

### DESCRIPTION OF EMBODIMENTS

However, in the optical waveguide disclosed in Patent Document 1, it is assumed that a loss is generated by reflection or interference due to low refractive index regions provided between the first core portion and the intersection portion and between the second core portion and the intersection portion. These low refractive index regions are present at input and output portions of the intersection portion, and two low refractive index regions are present at each intersection. Therefore, it is necessary to form all of these portions and regions with high accuracy, but it is difficult to form all of the low refractive index regions with high accuracy, and it is considered that the light transmission efficiency is reduced. As described above, there is room for improvement in the aspect disclosed in Patent Document 1.

The optical waveguide substrate, the optical module, and the information processing apparatus including the optical module disclosed in the present specification reduce an optical loss at the intersection portion of the optical waveguides and maintain high optical transmission efficiency.

Hereinafter, an embodiment of the present disclosure will be described with reference to the accompanying drawings. However, in the drawings, the dimensions, ratios, and the like of the respective parts may not be illustrated so as to completely match the actual ones. The drawings may be on different scales from one drawing to another. In addition, depending on the drawings, for convenience of description, there are cases where constituent elements that are actually present are omitted, or the dimensions are exaggerated compared to the actual dimensions.

### First Embodiment

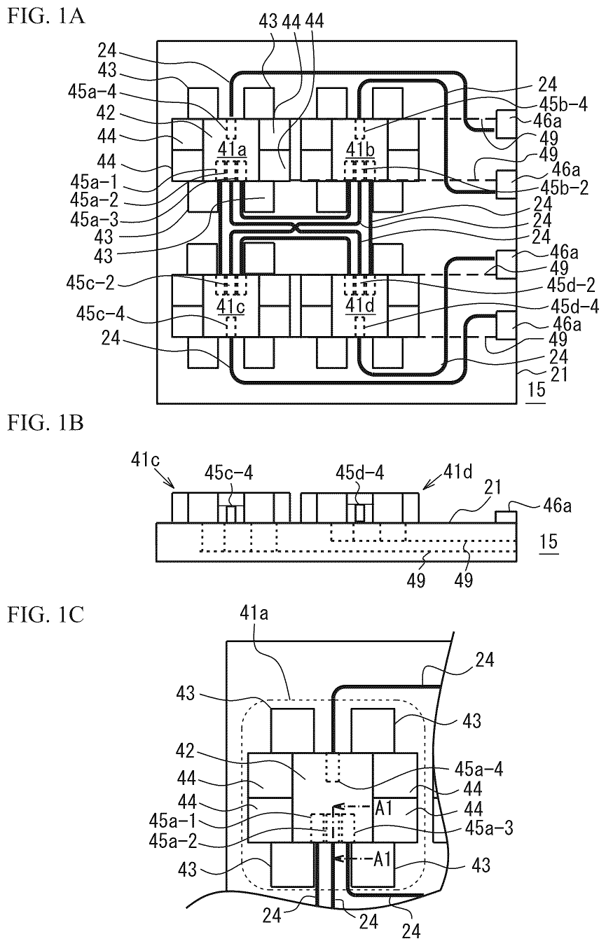

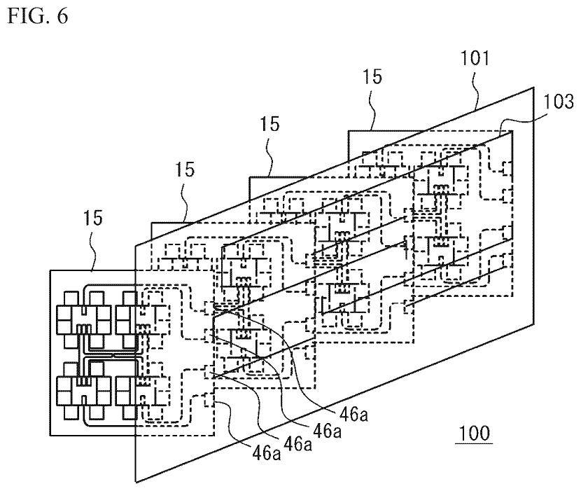

First, an optical waveguide substrate 21 having an optical waveguide structure according to a first embodiment (hereinafter, simply referred to as “optical waveguide substrate”) will be described with reference to FIGS. 1A to 6. The optical waveguide substrate 21 has optical waveguides 24, and operates as an optical module 15 by the function of an optical component or an electronic component mounted thereon, for example. The optical modules 15 are connected to a backboard 101 provided with optical wirings 103 via optical connectors 46a and are mounted on the information processing apparatus 100, as illustrated in FIG. 6 as an example.

The optical module 15 illustrated in FIG. 1A includes four information processing units, namely, a first information processing unit 41a, a second information processing unit 41b, a third information processing unit 41c, and a fourth information processing unit 41d. These four information processing units have the same configuration. FIG. 1B illustrates a front view of the optical module 15. Hereinafter, the first information processing unit 41a illustrated in an enlarged manner in FIG. 1C will be described as a representative example.

A plurality of chips having different functions are integrated in the first information processing unit 41a. For example, an input/output (IO) chip 42 serving as a signal input/output unit, a plurality of core chips 43, and a plurality of high bandwidth memories (HBMs) 44 are integrated. For example, the IO chip 42 controls input/output electric signals, and the core chip 43 is a central processing unit (CPU) that performs information processing. The OE chip is a chip that converts an optical signal from the optical waveguide 24 into an electrical signal or converts an electrical signal into an optical signal and outputs the optical signal to the optical waveguide. The first information processing unit 41a of the present embodiment includes a first OE chip 45a-1, a second OE chip 45a-2, a third OE chip 45a-3, and a fourth OE chip 45a-4, and is connected to the second to fourth information processing units, i.e., the second information processing unit 41b, the third information processing unit 41c, and the fourth information processing unit 41d, via optical waveguides 24.

The IO chip 42 receives electric signals converted from high-speed optical signals on the same substrate by the first OE chip 45a-1 and the like, controls or calculates the electric signals by the core chips 43, and stores the results in the HBMs 44. The IO chip 42 converts the controlled electric signal into an optical signal by, for example, the first OE chip 45a-1, and outputs the converted optical signal to a peripheral device, e.g., a first OE chip 45c-1 on the same substrate, or the like via the optical waveguides 24.

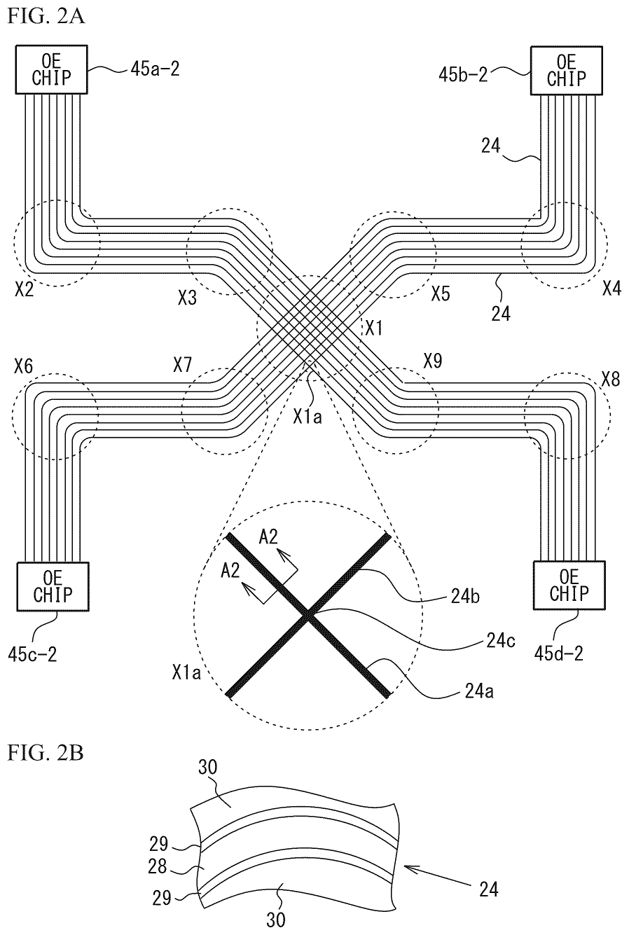

In the optical module 15, the first information processing unit 41a to the fourth information processing unit 41d exchange optical signals with each other via first OE chips 45a-1 to 45d-1 to third OE chips 45a-3 to 45d-3, respectively. The optical waveguide 24 provided in the optical waveguide substrate 21 is used for the exchange of the optical signal. In FIG. 1A, the optical waveguide 24 connected to each OE chip is drawn by one thick solid line, but in practice, the plurality of optical waveguides 24 are connected to one OE chip. Although FIG. 2A illustrates a state of connection between some of the OE chips, a plurality of optical waveguides are connected to one OE chip in the same manner in the other OE chips. In the present embodiment, an example in which eight optical waveguides are connected to one OE chip is illustrated. The number of optical waveguides 24 connected to one OE chip is not limited. The optical connector 46a is provided at the end of the optical waveguide 24 connected to the fourth OE chip 45a-4 included in the first information processing unit 41a. An optical fiber cable is connected to the optical connector 46a. The optical connectors 46a are also provided at the ends of the optical waveguides 24 connected to a fourth OE chip 45b-4 of the second information processing unit 41b, a fourth OE chip 45c-4 of the third information processing unit 41c, and a fourth OE chip 45d-4 of the fourth information processing unit 41d.

In order to connect the four information processing units to all the other information processing units on the optical waveguide substrate 21, the first information processing unit 41a and the third information processing unit 41c, and the second information processing unit 41b and the fourth information processing unit 41d are connected by straight optical waveguides, respectively, as illustrated in FIG. 1A. The first information processing unit 41a and the second information processing unit 41b, and the third information processing unit 41c and the fourth information processing unit 41d are connected by straight waveguides and curved waveguides. Further, the first information processing unit 41a and the fourth information processing unit 41d, and the second information processing unit 41b and the third information processing unit 41c are connected by straight waveguides and curved waveguides.

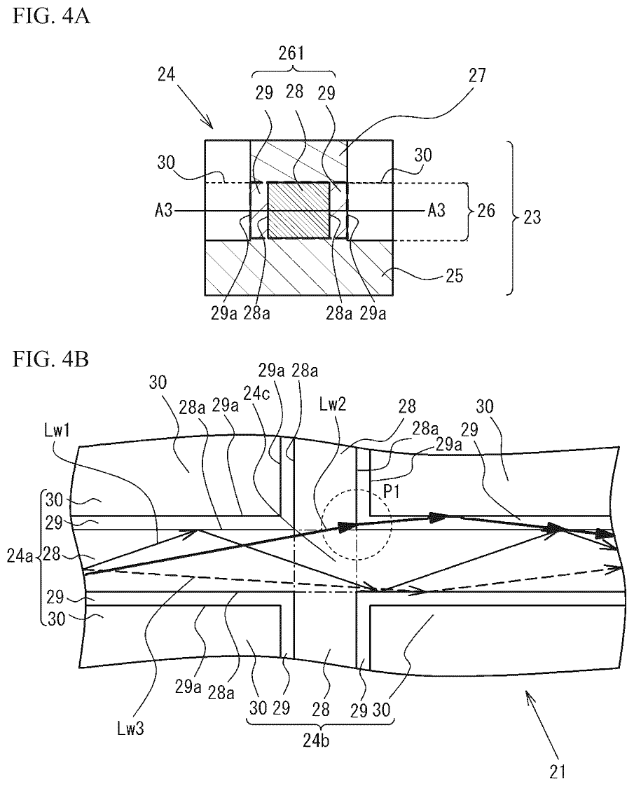

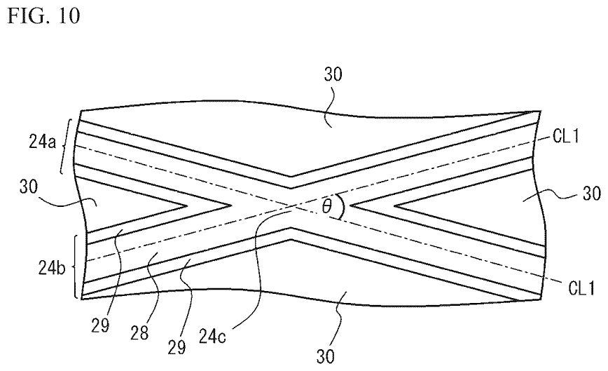

The first information processing unit 41a and the fourth information processing unit 41d are arranged on a diagonal line. The second information processing unit 41b and the third information processing unit 41c are arranged on a diagonal line. Therefore, the second OE chip 45a-2 included in the first information processing unit 41a and a second OE chip 45d-2 included in the fourth information processing unit 41d are connected to each other by the optical waveguides 24. A second OE chip 45b-2 included in the second information processing unit 41b and a second OE chip 45c-2 included in the third information processing unit 41c are connected to each other by the optical waveguides 24. Therefore, the optical waveguides 24 intersect each other in a region X1 illustrated in FIG. 2A. In the case where the optical waveguides 24 intersect each other in this manner, in the following description, one of the intersecting optical waveguides 24 is referred to as a first optical waveguide 24a, and the other is referred to as a second optical waveguide 24b (see a region X1a illustrated in an enlarged manner in FIG. 2A). Further, a portion where the first optical waveguide 24a and the second optical waveguide 24b intersect with each other is referred to as an intersection portion 24c. The intersection portion 24c is a region surrounded by a dashed-dotted line in FIG. 4B. In the present embodiment, an intersection angle θ between the first optical waveguide 24a and the second optical waveguide 24b is defined as illustrated in FIG. 10, and for example, in the case of being orthogonal, the intersection angle θ between the first optical waveguide 24a and the second optical waveguide 24b (see FIG. 10) is 90 degrees.

In the example illustrated in the present embodiment, since eight optical waveguides are connected to one OE chip, 8×8 intersection portions 24c are formed.

### [Configuration of Optical Waveguide Substrate]

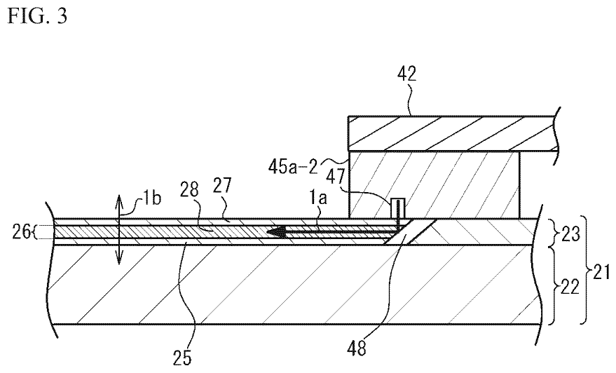

Here, the configuration of the optical waveguide substrate 21 will be described in detail with reference to FIGS. 3 and 4A. FIG. 3 is a cross-sectional view taken along a line A1-A1 in FIG. 1C. FIG. 4A is a cross-sectional view of an optical waveguide forming layer 23 taken along a line A2-A2 in the enlarged view of FIG. 2A. The optical waveguide substrate 21 includes a support layer 22. The support layer 22 can be formed of a conventionally known material for forming a substrate. The optical waveguide substrate 21 includes the optical waveguide forming layer 23 laminated on the upper side of the support layer 22. The optical waveguide forming layer 23 includes a lower cladding layer 25, a core portion forming layer 26, and an upper cladding layer 27 that are stacked in order from the position closer to the support layer 22. The core portion forming layer 26 is a layer including not only a core portion 261 in the same plane but also side cladding portions 30.

An arrow 1a illustrated in FIG. 3 indicates a light transmission direction. The light is irradiated by an optical pin 47, which is a light inputting portion of the second OE chip 45a-2 mounted on the optical waveguide substrate 21, and is introduced into the core portion forming layer 26 via a mirror 48.

The optical waveguide 24 is formed in the optical waveguide forming layer 23. The first optical waveguide 24a and the second optical waveguide 24b that intersect each other are also formed in the same optical waveguide forming layer 23. The optical waveguide 24 of the present embodiment is a multimode optical waveguide, but may be a single-mode optical waveguide.

The core portion 261 included in the core portion forming layer 26 includes a first core portion 28 and second core portions 29. A refractive index n_{core2} of the second core portion 29 is smaller than a refractive index n_{core1} of the first core portion 28. That is, n_{core2}<n_{core1} is satisfied. The second core portions 29 are disposed along both side surfaces 28a and 28a of the first core portion 28 in the cross section along the thickness direction of the optical waveguide forming layer 23, that is, the cross section illustrated in FIG. 4A. As a result, the first core portion 28 is interposed between the second core portions 29. Here, the thickness direction of the optical waveguide forming layer 23 is a direction indicated by a double-headed arrow 1b in FIG. 3, and coincides with the stacking direction of the support layer 22 and the optical waveguide forming layer 23.

In addition to the lower cladding layer 25 and the upper cladding layer 27, the side cladding portions 30 are provided around the core portion 261. The side cladding portions 30 are disposed along side surfaces 29a of the second core portions 29 on the sides opposite to the sides on which the first core portion 28 is located in the cross section along the thickness direction of the optical waveguide forming layer 23, that is, the cross section illustrated in FIG. 4A. As a result, the first core portion 28 and the second core portions 29 disposed on both sides of the first core portion 28 are interposed between the side cladding portions 30. The side cladding portion 30 in the present embodiment is, for example, an air layer.

The side cladding portion 30 has a lower refractive index n_{clad_side} than the refractive index n_{core2} of the second core portion 29, and a structure is formed in which n_{clad_side}<n_{core2} is satisfied. This enables the optical confinement in the lateral direction of the optical mode, that is, in the direction in which a line segment A3-A3 extends in FIG. 4A, and the side cladding portion 30 can exhibit the function of the cladding layer.

The refractive indices of the respective portions of the present embodiment are arranged as follows. The refractive index n_{core2} of the second core portion 29 is lower than the refractive index n_{core1} of the first core portion 28. The side cladding portion 30 has a lower refractive index n_{clad_side} than the refractive index n_{core2} of the second core portion 29. That is, it is sufficient that the relationship of n_{clad_side}<n_{core2}<n_{core1} is satisfied. If this relationship is satisfied, a refractive index n_{clad_lower} of the lower cladding layer 25 and a refractive index n_{clad_upper} of the upper cladding layer 27 can be set as appropriate. For example, the refractive index n_{clad_lower} of the lower cladding layer 25 and the refractive index n_{clad_upper} of the upper cladding layer 27 can be equal to the refractive index n_{core2} of the second core portion 29.

In this case, the lower cladding layer 25 and the upper cladding layer 27 may be formed using a material in which the refractive index of the lower cladding layer 25 and the refractive index of the upper cladding layer 27 are equal to the refractive index of the second core portion 29. For example, the lower cladding layer 25, the upper cladding layer 27, and the second core portion 29 can be manufactured by a manufacturing method of forming the same material. In this case, there is an advantage that the manufacturing labor of synthesizing a large number of different materials is saved.

The correlation between the refractive index n_{clad_lower} of the lower cladding layer 25, the refractive index n_{clad_upper} of the upper cladding layer 27, the refractive index n_{clad_core1} of the first core portion 28, the refractive index n_{clad_core2} of the second core portion 29, and the refractive index n_{clad_side} of the side cladding portion 30 will be described in detail. The loss in an intersection optical waveguide is mainly caused by scattering in the core portion forming layer 26, and it is considered that the light radiated into the core portion forming layer 26 rarely leaks to the lower cladding layer 25 or the upper cladding layer 27. Therefore, the values of the refractive index n_{clad_lower} of the lower cladding layer 25 and the refractive index n_{clad_upper} of the upper cladding layer 27 may be smaller than the value of the refractive index n_{core1} of the first core portion 28, and may be equal to the value of the refractive index n_{core2} of the second core portion 29, for example.

The values of the refractive index n_{clad_lower} of the lower cladding layer 25 and the refractive index n_{clad_upper} of the upper cladding layer 27 may be lower than the refractive n_{core2} of the second core portion 29. Further, the values of the refractive index n_{clad_lower} of the lower cladding layer 25 and the refractive index n_{clad_upper} of the upper cladding layer 27 may be higher than the refractive index n_{core2} of the second core portion 29, or may be values between the refractive index n_{core2} of the second core portion 29 and the refractive index n_{core1} of the first core portion 28. In this way, when the values of the refractive index n_{clad_lower} of the lower cladding layer 25 and the refractive index n_{clad_upper} of the upper cladding layer 27 are set to be higher than the refractive index n_{core2} of the second core portion 29, the lower cladding layer 25 and the upper cladding layer 27 may be made of any material having an effective refractive index n_{eff} or less, for example. Here, the effective refractive index n_{eff} indicates an effective refractive index of a propagation mode of the core portion 261 obtained by combining the first core portion 28 and the second core portions 29 in the core portion forming layer 26.

Specifically, the values of the refractive index n_{clad_lower} of the lower cladding layer 25 and the refractive index n_{clad_upper} of the upper cladding layer 27 may be values satisfying the relationship of the following equation (1).

$${n}_{c lad \_ upper} , {n}_{clad \_ lower} < \frac{{W}_{core 1} \times {n}_{Core 1} + 2 \times {W}_{core 2} \times {n}_{core 2}}{{W}_{core 1} + 2 \times {W}_{core 2}} \qquad [ Equation 1 ]$$

Wherein the refractive index of the upper cladding layer is n_{clad_upper}, the refractive index of the lower cladding layer is n_{clad_lower}, the refractive index of the first core portion is n_{core1}, the refractive index of the second core portion is n_{core2}, the refractive index of the side cladding portion is n_{clad_side}, the width of the first core portion is W_{core1}, and the width of the second core portion is W_{core2}.

### [Effect of Substrate Having Optical Waveguide Structure]

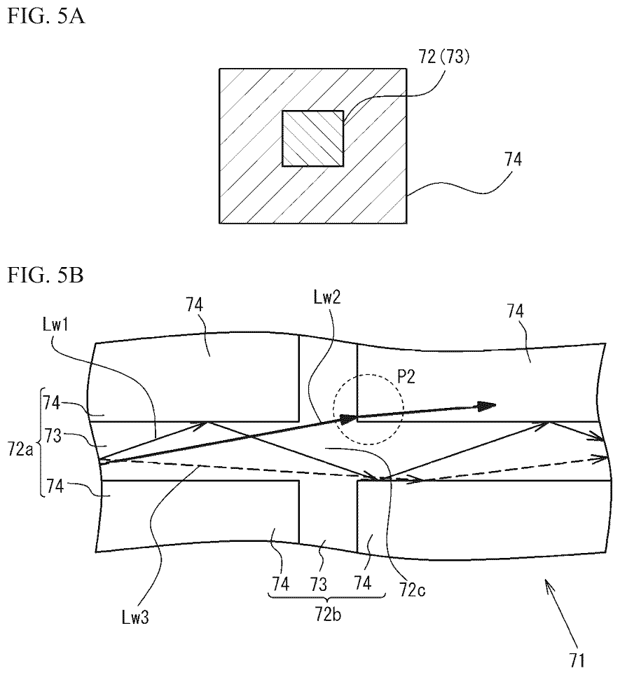

Next, with reference to FIGS. 4B to 5B, the effect of the optical waveguide substrate 21 will be described in comparison with a conventional example. FIG. 4B is a diagram schematically illustrating a state in which light travels in the optical waveguide formed in the optical waveguide substrate of the first embodiment. FIG. 5A is a cross-sectional view of an optical waveguide 72 having a conventional structure provided on an optical waveguide substrate 71. FIG. 5B is a diagram schematically illustrating a state in which light travels in the conventional optical waveguide 72. Note that FIG. 4B illustrates a state in which a surface obtained by cutting the optical waveguide substrate 21 at a height indicated by A3-A3 in FIG. 4A is viewed from above.

In FIG. 4B, the first optical waveguide 24a of the present embodiment extends in the horizontal direction of a paper surface. The second optical waveguide 24b extends in the vertical direction of the paper surface. The first optical waveguide 24a and the second optical waveguide 24b intersect at the intersection portion 24c. In the first optical waveguide 24a, a state in which light Lw1 of a first mode, light Lw2 of a second mode, and light Lw3 of a third mode are transmitted from the left to the right on the paper surface is schematically illustrated.

In the optical waveguide substrate 21 of the present embodiment, the light Lw1 of the first mode reaches boundary between the first core portion 28 and the second core portion 29 before or after passing through the intersection portion 24c, and is reflected. Accordingly, the light Lw1 of the first mode is transmitted so as to remain in the first core portion 28. Further, the light Lw3 of the third mode also reaches the boundary between the first core portion 28 and the second core portion 29 after passing through the intersection portion 24c and is reflected, and therefore, is transmitted so as to remain in the first core portion 28.

In contrast, the light Lw2 of the second mode deviates from the intersection portion 24c at a point P1 in FIG. 4B, and reaches the boundary between the first core portion 28 and the second core portion 29 at a position where the light Lw2 of the second mode enters the second optical waveguide 24b. As a result, the light Lw2 of the second mode is radiated from the first core portion 28 and enters the second core portion 29. However, the light Lw2 of the second mode radiated into the second core portion 29 is reflected toward the first core portion 28 at a point where the light LW2 reaches the boundary between the second core portion 29 and the side cladding portion 30. Then, the light is returned to the inside of the first core portion 28. This reduces light leakage, reduces light loss, and maintains high optical transmission efficiency.

Referring to FIG. 5B, the conventional optical waveguide substrate 71 includes a first optical waveguide 72a and a second optical waveguide 72b, similarly to the optical waveguide substrate 21 of the embodiment. The optical waveguide substrate 71 includes an intersection portion 72c where the first optical waveguide 72a and the second optical waveguide 72b intersect with each other. The intersection angle θ between the first optical waveguide 72a and the second optical waveguide 72b is 90 degrees. As illustrated in FIG. 5A, each of the first optical waveguide 72a and the second optical waveguide 72b includes a core portion 73. Cladding layers 74 are provided around the core portion 73. The first optical waveguide 72a illustrated in FIG. 5B extends in the horizontal direction of the paper surface. The second optical waveguides 72b extend in the vertical direction of the paper surface. Similarly to FIG. 4B, FIG. 5B schematically illustrates a state in which the light Lw1 of the first mode, the light Lw2 of the second mode, and the light Lw3 of the third mode are transmitted through the first optical waveguides 24a from the left to the right on the paper surface.

The light Lw1 of the first mode and the light Lw3 of the third mode in the conventional example are transmitted so as to remain in the core portion 73, similarly to the present embodiment. However, the light Lw2 of the second mode deviated from the intersection portion 72c penetrates the second optical waveguide 72b at a point P2 illustrated in FIG. 5B, and does not return to the core portion 73 while being radiated to the cladding layer 74. As a result, in the conventional example, the optical loss occurs, and the optical transmission efficiency is reduced.

As described above, the optical waveguide substrate 21 of the present embodiment has an effect of realizing high optical transmission efficiency because the radiation loss in a waveguide wall surface direction can be reduced. The same effect is exhibited at a connection portion between the mirror 48 and the optical waveguide 24 illustrated in FIG. 3. This further reduces the optical loss, and maintains high optical transmission efficiency of the optical waveguide substrate 21 as a whole.

The optical waveguide 24 provided on the optical waveguide substrate 21 may include a curved optical waveguide to change the angle of the optical waveguide from a region X2 to a region X8 illustrated in FIG. 2A. In such a curved waveguide, the presence of the first core portion 28 and the second core portion 29 allows light, which is not propagated in the first core portion 28 but penetrates the first core portion 28 and is radiated into the second core portion 29, to be reflected at the boundary between the second core portion 29 and the side cladding portion 30 and to be returned to the inside of the second core portion 29 and further to the inside of the first core portion 28. This reduces optical loss, maintains high optical transmission efficiency, and can provide the same effect even in a curved waveguide. Note that FIG. 2B specifically illustrates the structure of the curved waveguide.

### [Method of Manufacturing Optical Waveguide Substrate]

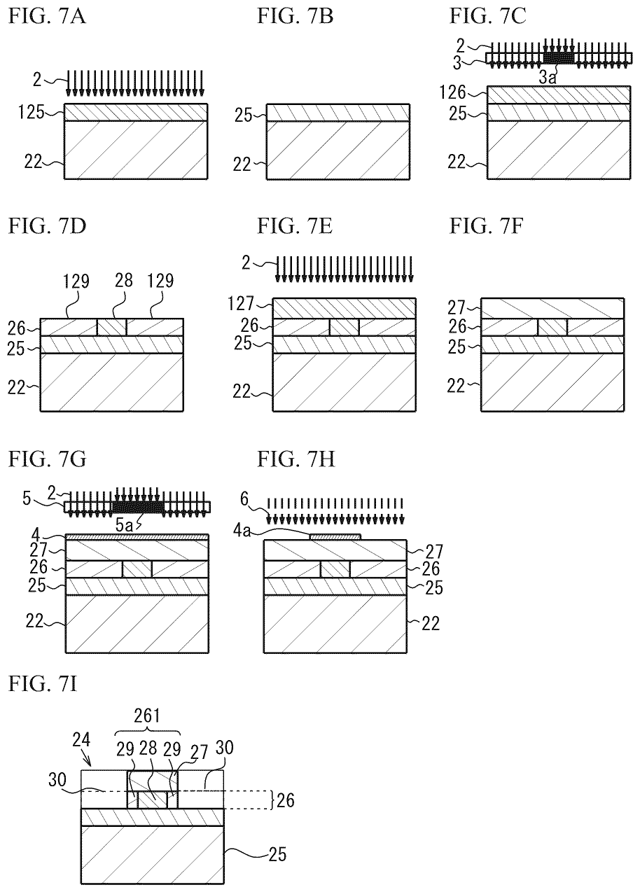

Next, an example of a method of manufacturing the optical waveguide substrate 21 of the present embodiment will be described with reference to FIGS. 7A to 7I.

First, a first exposure step is performed (FIG. 7A). In the first exposure step, a first layer 125 for forming the lower cladding layer 25 later is provided on the support layer 22, and the first layer 125 is irradiated with ultraviolet (UV) light 2. Next, a first heat treatment step is performed (FIG. 7B). Thus, the lower cladding layer 25 is formed.

Next, a second exposure step is performed (FIG. 7C). In the second exposure step, a second layer 126 for forming the core portion forming layer 26 later is provided on the lower cladding layer 25. Then, the second layer 126 is irradiated with the UV light 2 using a first photomask 3 having a mask portion 3a. The mask portion 3a is provided so as to correspond to the first core portion 28.

Next, a second heat treatment step is performed (FIG. 7D). Thus, the core portion forming layer 26 is formed. The core portion forming layer 26 at this time includes the first core portion 28 and a second core portion forming portion 129 which spreads around the first core portion 28 and becomes the second core portion 29 later. The second core forming portion 129 extends to a region to be included in the side cladding portion 30 later.

Next, a third exposure step is performed (FIG. 7E). In the third exposure step, a third layer 127 for forming the upper cladding layer 27 later is provided on the core portion forming layer 26. Then, the third layer 127 is irradiated with the UV light 2. Next, a third heat treatment step is performed (FIG. 7F). Thus, the upper cladding layer 27 is formed. The upper cladding layer 27 at this time extends to a region wider than a region where the upper cladding layer 27 is finally formed.

Next, a fourth exposure step is performed (FIG. 7G). In the fourth exposure step, a photoresist 4 is provided on the upper cladding layer 27. Then, the photoresist 4 is irradiated with the UV light 2 using a second photomask 5 having a mask portion 5a. The mask portion 5a is provided to correspond to a region of the first core portion 28 and the second core portions 29 provided on both sides thereof. As a result, a resist 4a is formed to cover the core portion 261 corresponding to the first core portion 28 and the second core portions 29 provided on both sides of the first core portion 28 (see FIG. 71), that is, a region corresponding to the width of the optical waveguide 24.

Next, an etching step is performed (FIG. 7H). In the present embodiment, reactive ion etching is performed by irradiating the substrate with ions 6. The irradiation intensity of the ions 6 is set to an intensity that can remove the upper cladding layer 27 and the core portion forming layer 26 and leave the lower cladding layer 25. As a result, spaces are formed on the sides of the second core portion 29 and the sides of the upper cladding layer 27, and these spaces form the side cladding portions 30 which are air layers. In this manner, the optical waveguide substrate 21 of the embodiment can be obtained (FIG. 71).

Here, combinations of materials that can be adopted for the optical waveguide substrate 21 of the first embodiment will be illustrated. However, the combinations illustrated below are examples, and the present embodiment is not limited to these.

### Combination Example of Materials

### (1) Example 1

Material of First Core Portion 28: Epoxy polymer (for example, product name: Ogsol EG (manufactured by Osaka Gas Chemicals Co., Ltd.)
Material of Second Core Portion 29: Mixture of epoxy polymer (for example, product name: Ogsol EG (manufactured by Osaka Gas Chemicals Co., Ltd.) and Celloxide 2021P (manufactured by Daicel Corporation)
Material of Side Cladding Portion 30: Air
Material of Lower Cladding Layer 25 and Upper Cladding Layer 27: Mixture of epoxy polymer (for example, product name: Ogsol EG (manufactured by Osaka Gas Chemicals Co., Ltd.) and Celloxide 2021P (manufactured by Daicel Corporation)

Example 1 is a combination of materials that have low losses in a band near an optical wavelength of 800 nm.

### (2) Example 2

Material of First Core Portion 28: Fluorine-containing polyaniline polymers
Material of Second Core Portion 29: Mixture of 70% by weight of 1,10-decanediol diacrylate and 30% by weight of fluorine-containing polyarylene polymer
Material of Side Cladding Portion 30: Air
Material of Lower Cladding Layer 25 and Upper Cladding Layer 27: Mixture of 70% by weight of 1,10-decanediol diacrylate and 30% by weight of fluorine-containing polyarylene polymer

Example 2 is a combination of materials with low losses in the band near the optical wavelength of 800 nm, a band near an optical wavelength of 1300 nm, and a band near an optical wavelength of 1500 nm.

### (3) Example 3

Material of First Core Portion 28: Mixture of polysiloxane and hydrolyzed silane compound
Material of Second Core Portion 29: Polysiloxane
Material of Side Cladding Portion 30: Air
Material of Lower Cladding Layer 25 and Upper Cladding Layer 27: Polysiloxane

Example 3 is a combination of materials that have low losses in the band near the optical wavelength of 1300 nm and in the band near the optical wavelength of 1500 nm.

### Second Embodiment

### [Configuration of Optical Waveguide Substrate]

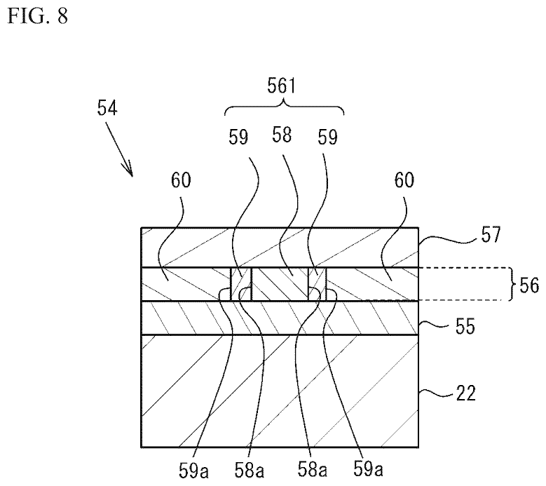

Next, a second embodiment will be described. FIG. 8 is a cross-sectional view schematically illustrating an optical waveguide 54 in a second embodiment. The second embodiment is different from the first embodiment in the configuration of side cladding portions 60.

The optical waveguide 54 includes the support layer 22, a lower cladding layer 55, a core portion forming layer 56, and an upper cladding layer 57. The core portion forming layer 56 includes a core portion 561 and the side cladding portions 60.

The core portion 561 included in the core portion forming layer 56 includes a first core portion 58 and a second core portion 59. The refractive index n_{core2} of the second core portion 59 is smaller than the refractive index n_{core1} of the first core portion 58. That is, “n_{core2}<n_{core1}” is satisfied. The second core portions 59 are disposed along both side surfaces 58a and 58a of the first core portion 58, similarly to the second core portion 29 in the first embodiment. As a result, the first core portion 58 is interposed between the second core portions 59.

The side cladding portions 60 are disposed along side surfaces 59a of the second core portions 59 which are opposite to the side surfaces 58a on which the first core portion 58 is located. As a result, the first core portion 58 and the second core portions 59 disposed on both sides of the first core portion 58 are interposed between the side cladding portions 60. The side cladding portion 60 in the present embodiment is a resin layer. This point is different from the first embodiment.

The refractive index of the side cladding portion 60 is lower than the refractive index of the second core portion 59. In the present embodiment, a material having a refractive index lower than that of the second core portion 59 is selected for the side cladding portion 60. Thereby, light is confined in the first core portion 58 and the second core portions 59. The order of the refractive index of each portion in the second embodiment can be set in the same manner as in the first embodiment, and thus the detailed description thereof will be omitted here.

### [Effects of Optical Waveguide Substrate]

The second embodiment including the optical waveguide 54 can also obtain the same effect as that of the first embodiment.

### [Method of Manufacturing Optical Waveguide Substrate]

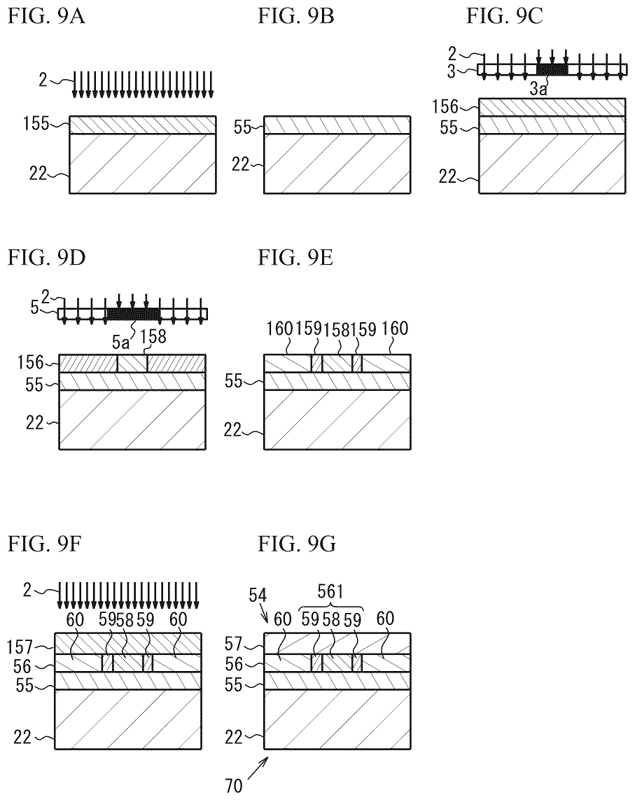

Next, an example of a method of manufacturing an optical waveguide substrate 70 of the second embodiment will be described with reference to FIGS. 9A to 9G.

First, the first exposure step is performed (FIG. 9A). In the first exposure step, a first layer 155 that forms the lower cladding layer 55 later is provided on the support layer 22, and the first layer 155 is irradiated with the UV light 2. Next, the first heat treatment step is performed (FIG. 9B). Thus, the lower cladding layer 55 is formed.

Next, the second exposure step is performed (FIG. 9C). In the second exposure step, a second layer 156 for forming the core portion forming layer 56 later is provided on the lower cladding layer 55. Then, the second layer 156 is irradiated with the UV light 2 using the first photomask 3 having the mask portion 3a. The mask portion 3a is provided to correspond to the first core portion 58. Thus, a first core portion forming portion 158 for forming the first core portion 58 later is formed.

Next, the third exposure step is performed (FIG. 9D). In the third exposure step, the second layer 156 is irradiated with the UV light 2 using the second photomask 5 having the mask portion 5a. The mask portion 5a is provided to correspond to a region of the first core portion 58 and the second core portions 59 provided on both sides thereof. As a result, second core portion forming portions 159 for forming the second core portions 59 later are formed on both sides of the first core portion forming portion 158. In addition, side cladding portion forming portions 160 for forming the side cladding portions 60 later are formed on both sides of the second core portion forming portions 159.

Next, the second heat treatment step is performed (FIG. 9E). Thus, the core portion forming layer 56 including the first core portion 58, the second core portions 59, and the side cladding portions 60 is formed.

Next, the fourth exposure step is performed (FIG. 9F). In the fourth exposure step, a third layer 157 for forming the upper cladding layer 57 later is provided on the core portion forming layer 56. Then, the third layer 157 is irradiated with the UV light 2. The second heat treatment step is performed, and thereby, the optical waveguide substrate 70 including the optical waveguide 54 is obtained (FIG. 9G).

Here, combinations of materials that can be adopted for the optical waveguide substrate 70 of the second embodiment will be illustrated. However, the combinations illustrated below are examples, and the present embodiment is not limited to these.

### Example of Combination of Materials

### (1) Example 1

Material of First Core Portion 58: Fluorine-containing polyaniline polymer
Material of Second Core Portion 59: Mixture of 50% by weight of 1,10-decanediol diacrylate and 50% by weight of fluorine-containing polyarylene polymer
Material of Side Cladding Portion 60: Mixture of 90% by weight of 1,10-decanediol diacrylate and 10% by weight of fluorine-containing polyarylene polymer
Material of Lower Cladding Layer 55 and Upper Cladding Layer 57: Mixture of 70% by weight of 1,10-decanediol diacrylate and 30% by weight of fluorine-containing polyarylene polymer

### (2) Example 2

Material of First Core Portion 58: Fluorine-containing polyaniline polymer
Material of Second Core Portion 59: Mixture of 50% by weight of polypropylene glycol dimethacrylate and 50% by weight of fluorine-containing polyarylene polymer
Material of Side Cladding Portion 60: Mixture of 90% by weight of polypropylene glycol dimethacrylate and 10% by weight of fluorine-containing polyarylene polymer
Material of Lower Cladding Layer 55 and Upper Cladding Layer 57: Mixture of 70% by weight of polypropylene glycol dimethacrylate and 30% by weight of fluorine-containing polyarylene polymer

### Modified Structure Example

Next, a modified structure example will be described with reference to FIG. 10. In the optical waveguide substrate 21 of the first embodiment, the intersection angle θ between the first optical waveguide 24a and the second optical waveguide 24b is 90 degrees as an example. In the present specification, as illustrated in FIG. 10, the intersection angle θ is an angle on an acute angle side among angles formed by a center line CL1 of the first optical waveguide 24a and a center line CL2 of the second optical waveguide 24b. When the center line CL1 is used as a reference, an obtuse angle adjacent to the intersection angle θ increases as the intersection angle θ decreases. The obtuse angle decreases as the intersection angle θ increases.

When the intersection angle θ becomes smaller than a threshold angle, a part of the light leaking from the first core portion 28 further transits to the second core portion 29.

When the angle at which the light is transferred to another intersection waveguide and the intensity thereof is rapidly increased is defined as a threshold angle, the threshold angle is determined by a difference between the effective refractive index of the first core portion 28 and the second core portion 29 and the refractive index of the side cladding portion 30. The intersection angle θ is set to an angle more suitable for the arrangement of the optical waveguide 24 and the OE chip in the optical waveguide substrate 21, and is preferably a value equal to or less than a threshold value. For example, the intersection angle is preferably 30 degrees or more and 90 degrees or less, and more preferably 45 degrees or more and 90 degrees or less. Therefore, the intersection angle θ can be set to, for example, 45 degrees or 60 degrees.

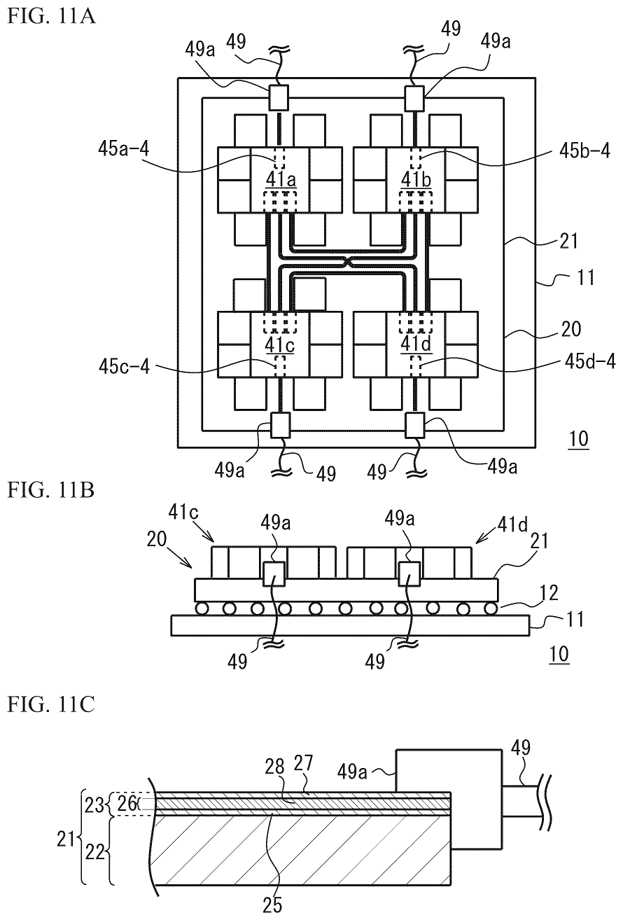

The optical waveguide substrate 21 illustrated in FIG. 11A operates as an optical module 20 by the function of the optical component and the electronic component mounted thereon, for example. The optical module 20 is mounted on a printed circuit board 11 using a ball grid array (BGA) 12, for example, as illustrated in FIG. 11B, and forms a package substrate 10. The electrical signals in the package substrate 10 are transmitted to and received from the outside via the BGA 12, and the optical signals are transmitted to and received from the outside via optical connectors 49a to which optical fiber cables 49 are connected.

### Example

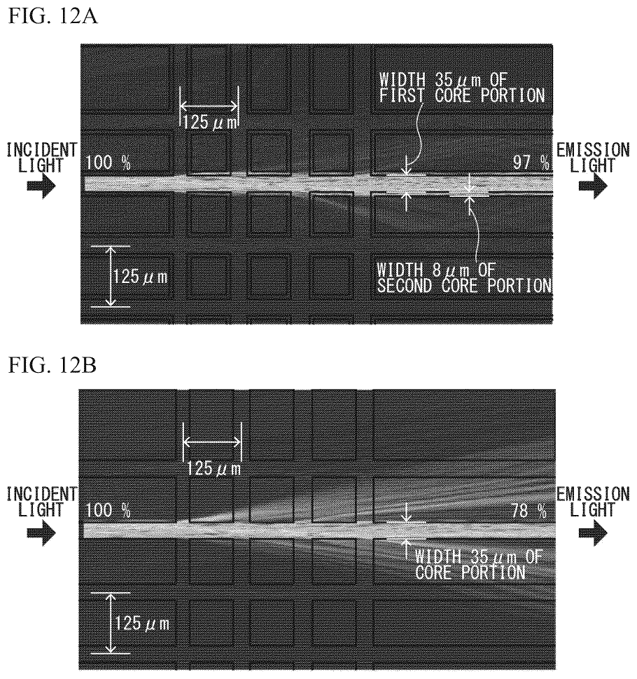

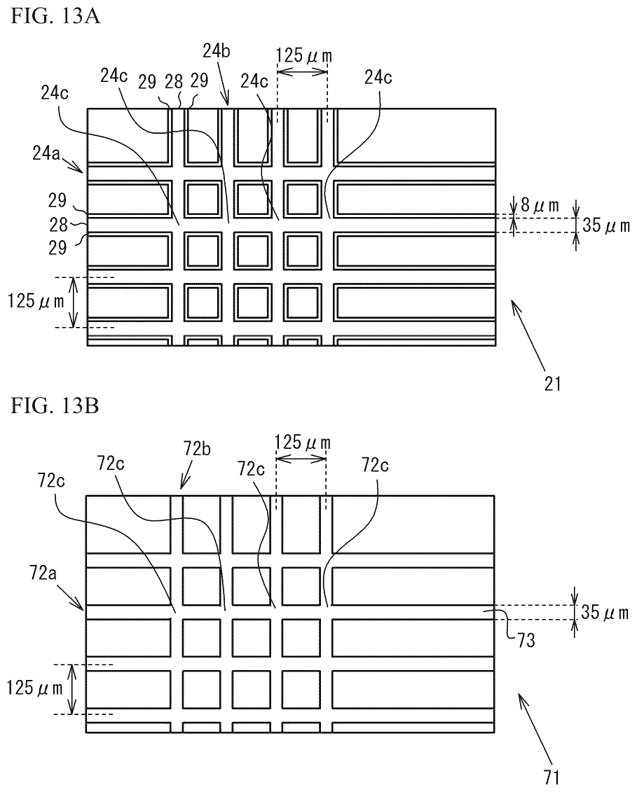

Next, an example will be described in comparison with a conventional example with reference to FIGS. 12A to 14. FIG. 12A illustrates the result of a finite-difference time-domain (FDTD) simulation performed on the structure of the example. FIG. 12B illustrates the result of the FDTD simulation performed on the structure of the conventional example. Here, the structure of the conventional example corresponds to the structure of the optical waveguide substrate 71 illustrated in FIGS. 5A and 5B. FIG. 13A is a plan view of the optical waveguide substrate 21 of the example, and the dimensions of the respective portions are illustrated. FIG. 13B is a plan view of the optical waveguide substrate 71 of the conventional example, and the dimensions of the respective portions are illustrated.

Hereinafter, the optical loss in the optical waveguide substrate 21 of the example and the optical waveguide substrate 71 of the conventional example was calculated, and the effectiveness thereof was verified. However, the verification by the simulation calculation was performed for a structure in which the number of intersection portions was 4×4 and a structure in which the number of intersection portions was 8×8.

The verification was performed using a two dimensional finite-difference time-domain (FDTD) method. The FDTD method is an electromagnetic numerical analysis method extended to a time change, and can calculate not only the scattering at the intersection portion but also the influence of the reflected light.

First, a structure in which the number of intersection portions is 4×4 will be described. An interval between the first optical waveguides 24a is 125 μm, and an interval between the second optical waveguides 24b is 125 μm. The intersection angle θ is 90 degrees. A width of the first core portion 28 is 35 μm, and a width of the second core portion 29 is 8 μm.

On the other hand, an interval between the first optical waveguides 72a and an interval between second optical waveguides 74b in the conventional example are also 125 μm. The width of the core portion 73 is 35 μm.

Since it is desired that the incident light has a sufficient high-order mode, the fundamental mode is disturbed by a curved waveguide, a tapered waveguide, or the like to produce a spectrum sufficiently including the high-order mode, and the same spectrum is made incident on both structures.

The light was incident on the first optical waveguide 24a of the example from the left side of the sheet surface in FIG. 12A and passed through the four intersection portions 24c. On the other hand, the light was incident on the first optical waveguide 72a of the conventional example from the left side of the sheet surface in FIG. 12B and passed through the four intersection portions 72c.

As a result, in the example, the light was transmitted without being scattered at the intersection portions 24c, and the transmission efficiency was 97%. On the other hand, in the conventional example, the light was scattered every time it passed through each intersection portion 72c, and the transmission efficiency was 78%. That is, the transmission efficiency of the embodiment was improved by 19% compared to the conventional example.

When the example was compared with the conventional example with the intersection angle θ set to 60 degrees, the transmission efficiency of the example was 94%, which was improved from the conventional example in which the transmission efficiency was 68%.

Similarly, when the example was compared with the conventional example with the intersection angle θ set to 45 degrees, the transmission efficiency of the example was 93%, which was improved from the conventional example in which the transmission efficiency was 70%.

In the case of the structure in which the intersection portion is 4×4, when the interval between the adjacent optical waveguides is set to 125 μm, the dimension of the region in which the intersection portion is formed is a small size of 500 μm×500 μm or less.

By adopting the aspect of the example, it is possible to suppress the leakage of light and suppress the decrease in the transmission efficiency of each optical waveguide, and it is possible to realize the miniaturization and the low loss at the same time. Further, the region where the intersection portion is formed is reduced, and even if the adjacent optical waveguides are close to each other, crosstalk or the like is effectively suppressed.

Next, a structure in which the intersection is 8×8 will be described. The verification by the simulation calculation was performed in the same manner as in the case where the number of intersection portions was 4×4.

In this case, the improvement of the transmission efficiency was also confirmed, and for example, when the intersection angle θ was 60 degrees, the transmission efficiency was 80% in the example, and the improvement of 30% was observed as compared with the transmission efficiency of 50% in the conventional example.

In the case where the number of the intersection portions is 8×8, when the interval between the adjacent optical waveguides is set to 125 μm, the size of the region where the intersection portion is formed is a small size of 1000 μm×1000 μm or less. By adopting the aspect of the example, it is possible to suppress the leakage of light and suppress the decrease in the transmission efficiency of each optical waveguide, and it is possible to realize the miniaturization and the low loss at the same time. Therefore, even if the region where the intersection is formed is reduced, the leakage light can be suppressed, and thus the crosstalk between the adjacent optical waveguides is suppressed.

Here, in order to verify a manufacturing margin for realizing an appropriate width dimension in the second core portion 29, a result of verification in which simulation calculation is performed in the same manner as described above while changing the width of the second core portion 29 will be illustrated.

The verification was performed with a structure in which the width of the second core portion 29 was changed in a range of 0 μm to 18 μm and the number of intersection portions was 4×4. The interval between the first optical waveguides 24a and the interval between the second optical waveguides 24b were each 125 μm. The intersection angle θ was 90 degrees. The width of the first core portion 28 was 35 μm.

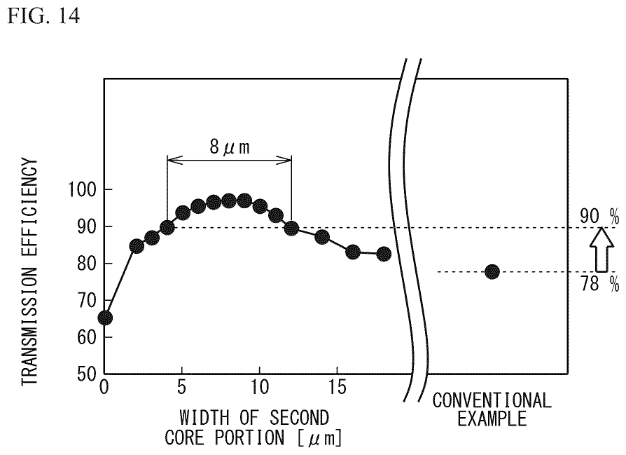

FIG. 14 illustrates the dependence of the light transmission efficiency on the width of the second core portion 29, and also illustrates the transmission efficiency of the conventional example. The conventional example corresponds to a mode in which the entire region of the core portion is the second core portion.

Referring to FIG. 14, the transmission efficiency increases as the width of the second core portion 29 increases, and the result that the transmission efficiency of the light is 90% or more in the range of the width from 4 μm to 12 μm is obtained. When the width exceeds 12 μm, the light transmission efficiency gradually decreases and converges to a value of the transmission efficiency of the conventional example, that is, a mode in which the second core portion 29 indicates the entire core portion. Therefore, the verification result is considered to be valid.

In FIG. 14, it was confirmed that the range in which the light transmission efficiency of 90% or more was obtained was 8 μm, which was sufficient as a manufacturing margin.

That is, according to the optical waveguide substrate 21 of the example, the allowable range of the error that may occur in the width of the second core portion 29 at the time of manufacturing is wide, and strict dimensional management at the time of manufacturing is not required.

### EFFECTS

Hereinafter, effects of the substrate disclosed in the present specification will be described.

The optical waveguide substrate disclosed herein includes the first core portion and the second core portions extending along the light transmission direction. The second core portions are disposed along both side surfaces of the first core portion in a cross section along the thickness direction of the optical waveguide forming layer. The side cladding portions are disposed outside the second core portions. Thus, the light emitted from the intersection portion between the first optical waveguide and the second optical waveguide is reflected at the boundary between the second core portion and the side cladding portion, and is returned to the inside of the second core portion and further to the inside of the first core portion 28. This reduces the optical loss and maintains high optical transmission efficiency.

In the optical waveguide substrate disclosed herein, the refractive index of the lower cladding layer and the refractive index of the upper cladding layer may be the same as the refractive index of the second core portion. This facilitates selection of the material.

In the optical waveguide substrate disclosed herein, the side cladding portion may be an air layer. This eliminates the need to select the material of the side cladding portion.

In the above embodiment, the optical waveguide includes the first core portion 28 and the second core portions 29 disposed on both sides of the first core portion 28, but other core portions may be further disposed on both sides of the second core portions 29. At this time, it is desirable that the refractive index of the other core portions disposed on both sides of the second core portions 29 is set to be lower than the refractive index of the second core portions 29. The number of other core portions may be plural. It is desirable that the refractive index of the other core portions is set to be lower toward the outside.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. An optical waveguide substrate having an optical waveguide structure comprising:
a support layer; and
an optical waveguide forming layer including a lower cladding layer provided on the support layer, a core portion forming layer provided on the lower cladding layer, and an upper cladding layer provided on the core portion forming layer;
wherein the optical waveguide forming layer includes a first optical waveguide and a second optical waveguide intersecting the first optical waveguide,
each of the first optical waveguide and the second optical waveguide includes a core portion extending along a light transmission direction in the core portion forming layer, and a side cladding portion,
the core portion includes a first core portion and a second core portion,
the second core portion is disposed along both side surfaces of the first core portion in a cross section along a thickness direction of the optical waveguide forming layer,
the side cladding portion is disposed on a side surface of the second core portion opposite to a side on which the first core portion is located in the cross section along the thickness direction of the optical waveguide forming layer,
a refractive index of the second core portion is smaller than a refractive index of the first core portion, and
a refractive index of the side cladding portion is smaller than the refractive index of the second core portion.

2. The optical waveguide substrate having the optical waveguide structure according to claim 1,
wherein a refractive index of the lower cladding layer and a refractive index of the upper cladding layer are the same as the refractive index of the second core portion.

3. The optical waveguide substrate having the optical waveguide structure according to claim 1,
wherein the side cladding portion is an air layer.

4. The optical waveguide substrate having the optical waveguide structure according to claim 1,
wherein an intersection angle between the first optical waveguide and the second optical waveguide is 30 degrees or more and 90 degrees or less.

5. The optical waveguide substrate having the optical waveguide structure according to claim 1,
wherein an intersection angle between the first optical waveguide and the second optical waveguide is 45 degrees or more and 90 degrees or less.

6. An optical module comprising:
an optical waveguide substrate having an optical waveguide structure; and
a photoelectric conversion element mounted on the optical waveguide substrate;
wherein the optical waveguide substrate includes:
a support layer; and
an optical waveguide forming layer including a lower cladding layer provided on the support layer, a core portion forming layer provided on the lower cladding layer, and an upper cladding layer provided on the core portion forming layer;
wherein the optical waveguide forming layer includes a first optical waveguide and a second optical waveguide intersecting the first optical waveguide,
each of the first optical waveguide and the second optical waveguide includes a core portion extending along a light transmission direction in the core portion forming layer, and a side cladding portion,
the core portion includes a first core portion and a second core portion,
the second core portion is disposed along both side surfaces of the first core portion in a cross section along a thickness direction of the optical waveguide forming layer,
the side cladding portion is disposed on a side surface of the second core portion opposite to a side on which the first core portion is located in the cross section along the thickness direction of the optical waveguide forming layer,
a refractive index of the second core portion is smaller than a refractive index of the first core portion,
a refractive index of the side cladding portion is smaller than the refractive index of the second core portion, and
the photoelectric conversion element is connected to the first optical waveguide or the second optical waveguide.

7. An information processing apparatus comprising:
an optical module including an optical waveguide substrate having an optical waveguide structure and a photoelectric conversion element mounted on the optical waveguide substrate; and
a substrate on which the optical module is mounted;
wherein the optical waveguide substrate includes:
a support layer; and
an optical waveguide forming layer including a lower cladding layer provided on the support layer, a core portion forming layer provided on the lower cladding layer, and an upper cladding layer provided on the core portion forming layer;
wherein the optical waveguide forming layer includes a first optical waveguide and a second optical waveguide intersecting the first optical waveguide,
each of the first optical waveguide and the second optical waveguide includes a core portion extending along a light transmission direction in the core portion forming layer, and a side cladding portion,
the core portion includes a first core portion and a second core portion,
the second core portion is disposed along both side surfaces of the first core portion in a cross section along a thickness direction of the optical waveguide forming layer,
the side cladding portion is disposed on a side surface of the second core portion opposite to a side on which the first core portion is located in the cross section along the thickness direction of the optical waveguide forming layer,
a refractive index of the second core portion is smaller than a refractive index of the first core portion,
a refractive index of the side cladding portion is smaller than the refractive index of the second core portion, and
the photoelectric conversion element is connected to the first optical waveguide or the second optical waveguide.
